(19) United States
(12) Patent Application Publication
(10) Pub. No.: US 2022/0196949 A1
(43) Pub. Date: Jun. 23, 2022

(54) CABLE SEAL AND ATTACHMENT ASSEMBLY

(71) Applicant: COMMSCOPE CONNECTIVITY BELGIUM BVBA, Kessel-Lo (BE)

(72) Inventors: Samory DE ZITTER, Mechelen (BE); Mohamed AZNAG, Scherpenheuvel Zichem (BE)

(73) Assignee: COMMSCOPE CONNECTIVITY BELGIUM BVBA, Kessel-Lo (BE)

(21) Appl. No.: 17/603,911

(22) PCT Filed: Apr. 14, 2020
(86) PCT No.: PCT/EP2020/060494

§ 371 Date: Oct. 14, 2021

Related U.S. Application Data
(60) Provisional application No. 62/834,024, filed on Apr. 15, 2019.

(51) Int. Cl. G02B 6/44

(52) U.S. Cl. CPC G02B 6/4444

(57) ABSTRACT

Aspects of the present disclosure relates to a sealing unit for sealing an optical fiber cable. The sealing unit can include a body member that defines a passage that extends lengthwise therethrough, and a first cavity adjacent a proximal end where the first cavity has a first diameter and a second cavity adjacent a distal end where the second cavity has a second diameter. A sealing member that has a distal end face and a proximal end face, The sealing member can be mounted within the first cavity of the body member and configured to create a seal about the optical fiber cable when the optical fiber cable is routed therethrough. When in use, a duct can be rotated inside the second cavity of the body member such that internal threads of the second cavity cut into the duct to drive the duct forward to abut the distal end face of the sealing member to prevent a leak path.

### CROSS-REFERENCE TO RELATED APPLICATION

This application claims the benefit of U.S. Patent Application Ser. No. 62/834,024, filed on Apr. 15, 2019, the disclosure of which is incorporated herein by reference in its entirety.

### TECHNICAL FIELD

The present disclosure relates to cable termination units, and more particularly to termination units including cable seals for fiber optic cables.

### BACKGROUND

Telecommunications system typically employ a network of telecommunications cables capable of transmitting large volumes of data and voice signals over relatively long distances. Telecommunications cables can include fiber optic cables, electrical cables, or combinations of electrical and fiber optic cables. A typical telecommunications network also includes a plurality of telecommunications enclosures integrated throughout the network of telecommunications cables. The telecommunications enclosures or “closures” are adapted to house and protect telecommunications components such as splices, termination panels, power splitters, and wave division multiplexers.

It is often preferred for telecommunications enclosures to be re-enterable. The term “re-enterable” means that the telecommunications enclosures can be reopened to allow access to the telecommunications components housed therein without requiring the removal and destruction of the telecommunications enclosures. For example, certain telecommunications enclosures can include separate access panels that can be opened to access the interiors of the enclosures, and then closed to reseal the enclosures. Other telecommunications enclosures take the form of elongated sleeves formed by wrap around covers or half-shells having longitudinal edges that are joined by clamps or other retainers. Still other telecommunications enclosures include two half-pieces that are joined together through clamps, wedges or other structures. Telecommunications enclosures are typically sealed to inhibit the intrusion of moisture or other contaminants.

### SUMMARY

The present disclosure relates to a cable termination unit that is adapted to simultaneously fix and seal fiber optic cables. In one possible configuration and by non-limiting example, the cable termination unit is in a telecommunications enclosure. Various aspects are described in this disclosure, which include, but are not limited to, the following aspects.

One aspect of the present disclosure relates to a sealing unit for sealing an optical fiber cable. The sealing unit includes a body member and a sealing member. The body member defines a first cavity that has a first diameter and a second cavity that has a second diameter. The sealing member can be mounted within the first cavity to create a seal about the optical fiber cable.

In certain examples, the body member defines a passage that extends lengthwise between a distal end and a proximal end of the body member.

In certain examples, the passage includes internal threads within the second cavity of the body member.

In certain examples, the first cavity is located adjacent to the proximal end of the body member and the second cavity is located adjacent to the distal end of the body member.

In certain examples, the sealing member has a distal end face and a proximal end face.

In certain examples, the sealing member defines a passage for receiving the optical fiber cable to provide the seal thereabout.

In certain examples, when in use, a duct can be rotated inside of the second cavity of the body member such that the internal threads of the second cavity cut into the duct to drive the duct forward to abut the distal end face of the sealing member.

In certain examples, the body member includes two halves.

In certain examples, the body member can be attached to a cable termination unit via a strap.

In certain examples, the strap can include a loop configured to mount within a recess of the body member. The strap can have two free ends that can be configured to be received within receptacles on opposite sides of the cable termination unit to secure the body member thereto.

Another aspect of the present disclosure relates to a method for sealing and fixing a duct for routing an optical fiber cable.

In certain examples, the method includes the following steps: providing a duct that includes an optical fiber cable; mounting a sealing member around the optical fiber cable such that an end face of the sealing member abuts the duct; joining two halves of a sealing unit together over the sealing member and the duct; attaching a strap to the sealing unit; tightening the strap over the sealing unit to squeeze the sealing member over the fiber optic cable and to squeeze the duct; twisting the duct against threads in the sealing unit such that the duct is sealed against the sealing member; and screwing a fastener into the sealing unit to engage and axially secure the duct.

The method can further include a step of attaching the sealing unit to a cable termination unit.

A further aspect of the present disclosure relates to a sealing coupling component that can include a sealing unit, a sealing member, an optical fiber cable, and a duct.

In certain examples, the sealing unit can include a body member. The body member may include a first end and an opposite second end. The body member may define an inner passage that extends through the body member between the first and second ends of the body member along an axis.

The body member may have a first housing piece and a second housing piece that can be configured to mate together. The first housing piece may define a first cavity with a first diameter and the second housing piece may define a second cavity with a second diameter.

In certain examples, the second cavity may have internal metal threads.

In certain examples, the sealing member may be located in the first cavity. The sealing member can define a passage. An optical fiber cable can be positioned within the passage of the sealing member. The sealing member can provide a seal about the optical fiber cable.

The duct can be adapted to mount into the second cavity such that the internal metal threads cut into the duct to drive the duct forward to abut against an end face of the sealing member to prevent fluid flow through the sealing unit when the first and second housing pieces are in a closed position.

In certain examples, the sealing unit can be attached to a cable termination unit via a strap.

In certain examples, the strap can include a loop configured to mount within a recess of the sealing unit.

In certain examples, the strap can have two free ends adapted to be positioned on opposing sides of the cable termination unit to secure the sealing unit to the cable termination unit.

### BRIEF DESCRIPTION OF THE DRAWINGS

The accompanying drawings, which are incorporated in and constitute a part of the description, illustrate several aspects of the present disclosure. A brief description of the drawings is as follows:

FIG. 1 is a perspective view of a telecommunications enclosure in accordance with an exemplary embodiment of the present disclosure.

FIG. 2 show in cross-section the telecommunication enclosure of FIG. 1.

FIG. 3 is a top view of a seal block including cable termination units in accordance with the principles of the present disclosure.

FIG. 4 is a cross-sectional view of the seal block of FIG. 3.

FIG. 5 is a perspective exploded view of another cable termination unit in accordance with the principles of the present disclosure.

FIG. 6 is a perspective view of a sealing unit mounted to the cable termination unit of FIG. 5 in accordance with the principles of the present disclosure.

FIG. 7 is a bottom perspective view of FIG. 6.

FIG. 8 is a side view of FIG. 6.

FIG. 9 is a cross-sectional view of FIG. 8.

FIG. 10 is an end view of the sealing unit FIG. 6.

FIG. 11 is a cross-sectional side perspective view of the sealing unit of FIG. 10.

FIG. 12 is a top perspective view of one half of the sealing unit of FIG. 11.

FIG. 13 is a top plan view of FIG. 8.

FIG. 14 is a cross-sectional view taken along section line 14-14 of FIG. 13.

FIG. 15 is a cross-sectional view taken along section line 15-15 of FIG. 13.

FIG. 16 is a perspective view of FIG. 6 with a strap exploded from the sealing unit.

FIG. 17 is a perspective view of FIG. 16 with the sealing unit exploded.

FIG. 18 is a perspective bottom view of FIG. 17.

FIG. 19 is an exploded view of FIG. 16.

FIGS. 20-22 are multiple views of a sealing member in accordance with the principles of the present disclosure.

### DETAILED DESCRIPTION

Various embodiments will be described in detail with reference to the drawings, wherein like reference numerals represent like parts and assemblies throughout the several views.

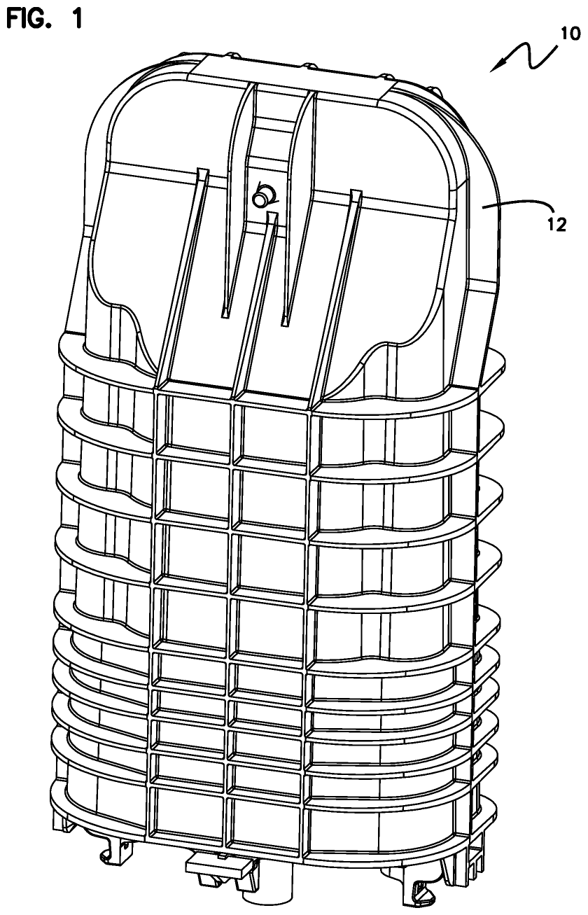

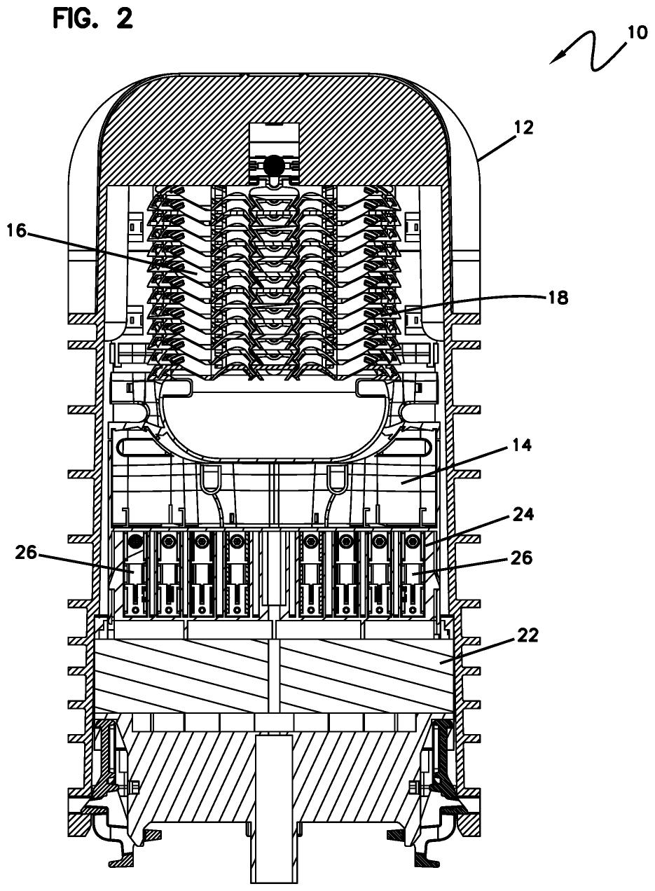

Referring to FIGS. 1-2, a telecommunications enclosure 10 is depicted in accordance with an exemplary embodiment of the present disclosure. It is understood that other types of telecommunications closures can be used to employ various embodiments of the present disclosure.

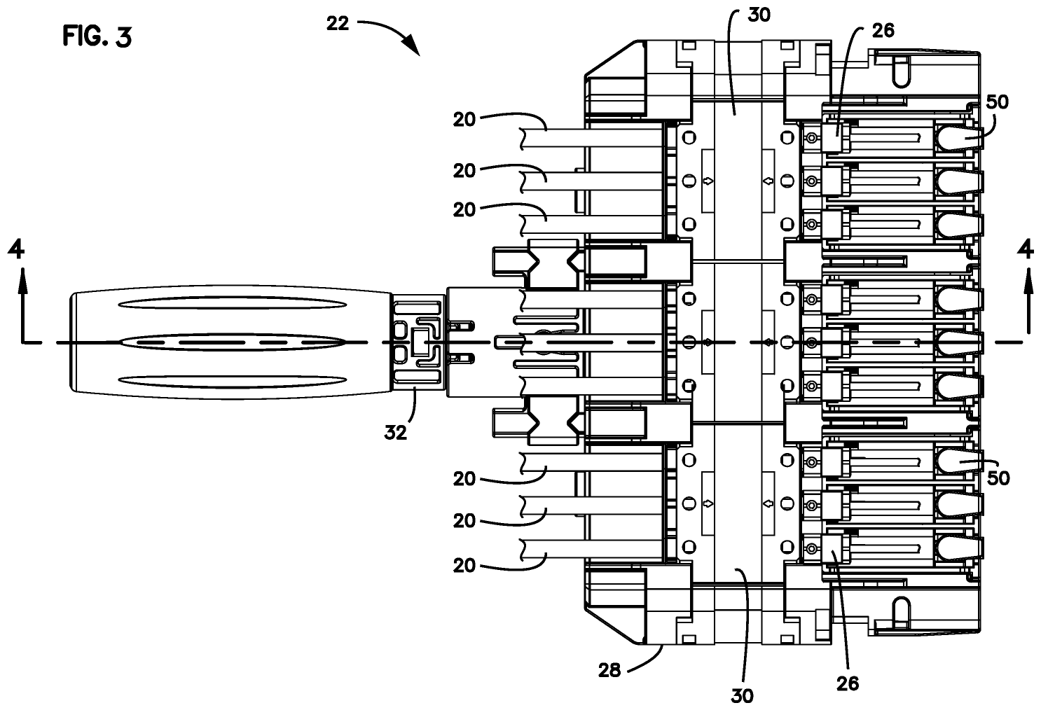

As illustrated, the telecommunications enclosure 10 includes a cover 12 with an interior frame 14. The interior frame 14 holds telecommunications equipment 16, such as a plurality of trays 18 in the example shown. Various optical fiber cable 20 (see FIG. 3) enter and exit the telecommunications enclosure 10 through a gel block or seal block 22. The interior frame 14 includes a clamp assembly holder 24 for holding a cable termination unit 26 (e.g., a clamp assembly) attached to each optical fiber cable 20 to retain each optical fiber cable 20 with the telecommunications enclosure 10. The cable termination unit 26 can be provided to clamp to the optical fiber cable 20 and to be retained by the clamp assembly holder 24 of the telecommunications enclosure 10. The cable termination unit 26 fixes the optical fiber cable 20.

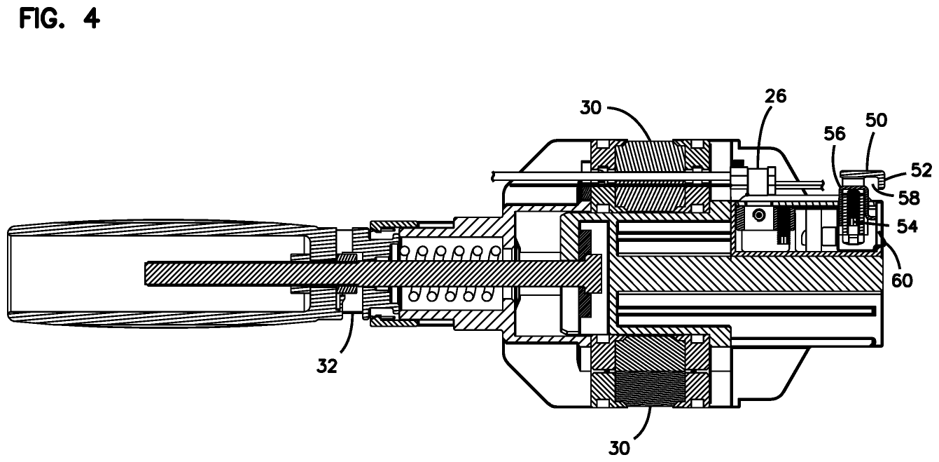

FIGS. 3-4 show the seal block 22 with a sealing unit 28 and cable sealing modules 30 for sealing optical fiber cables 20 entering the telecommunications enclosure 10. In certain examples, an actuator or trigger 32 can be used to cause the sealing unit 28 to seal to the optical fiber cables 20. The cable termination unit 26 is adapted to clamp the optical fiber cable 20 to the seal block 22.

Each cable 20 can include a cable jacket 34 which surrounds one or more fiber optic cables, or tubes containing fibers. The optical fiber cables 20 can also include one or more strength members. The strength members can be glass-filled rods and/or flexible yarns.

In certain examples, the optical fiber cable 20 can be clamped to the cable termination unit 26 outside and separate from the telecommunications enclosure 10. Such a feature promotes ease of use for the technician. Once the cable termination unit 26 is mounted to the optical fiber cables 20, the optical fiber cables 20 and the cable termination units 26 can be mounted to the telecommunications enclosure 10. Such a feature is also useful for later working on a cable if the enclosure needs to be re-entered.

In certain examples, the cable termination unit 26 can include a strength member clamp assembly 50 and includes a cover member 52 which can press against a strength member of the optical fiber cable 20 by a first fastener 54 and pressing element 56. In the example depicted, the cover member 52 is L-shaped, although alternatives are possible. The cover member 52 defines a strength member pocket 58 for a strength member of the optical fiber cable 20.

In certain examples, the strength member clamp assembly 50 of the cable termination unit 26 may include a grounding clip 60 to allow for grounding of a metallic shield of the optical fiber cable 20 to a ground connection associated with the interior frame 14.

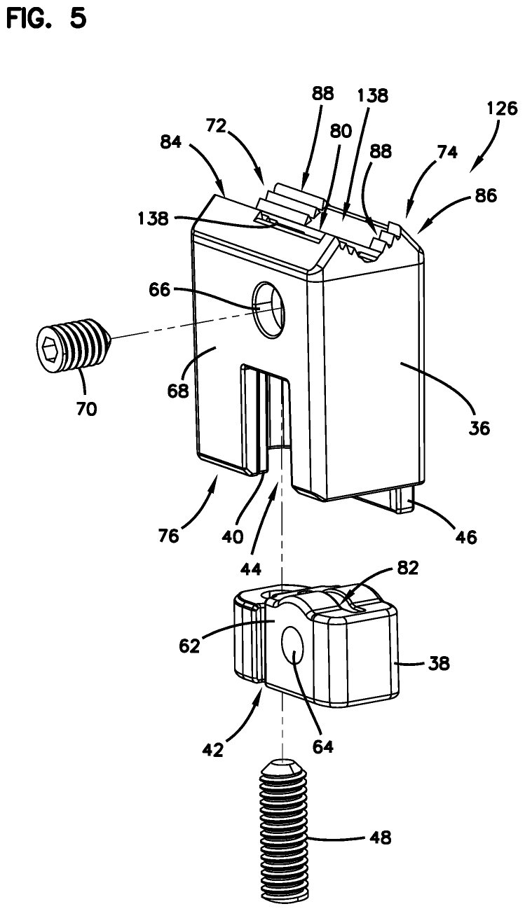

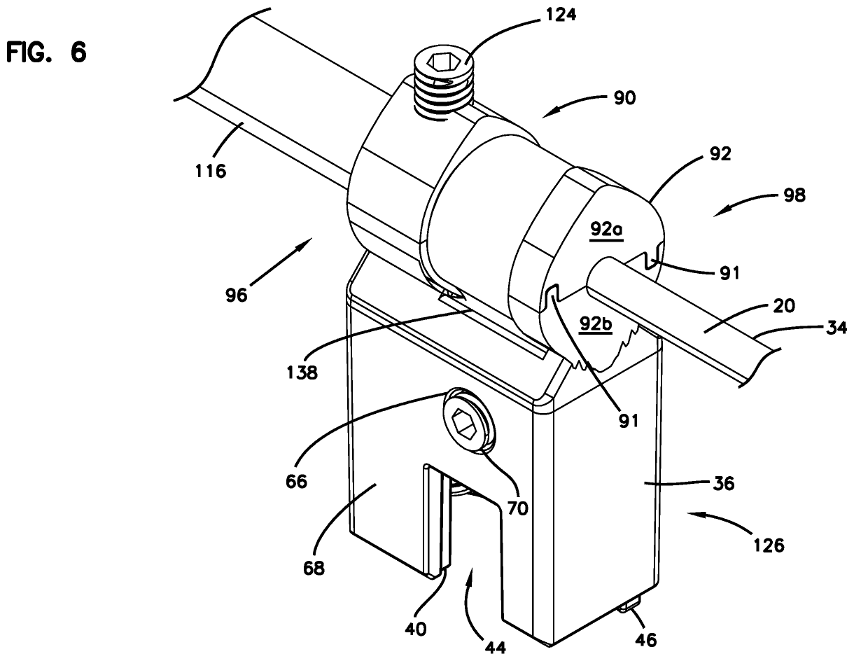

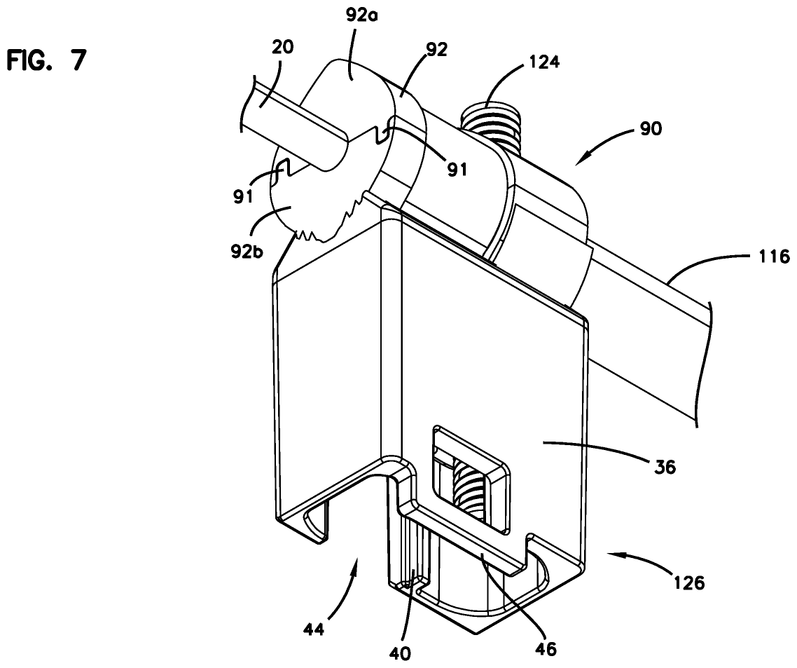

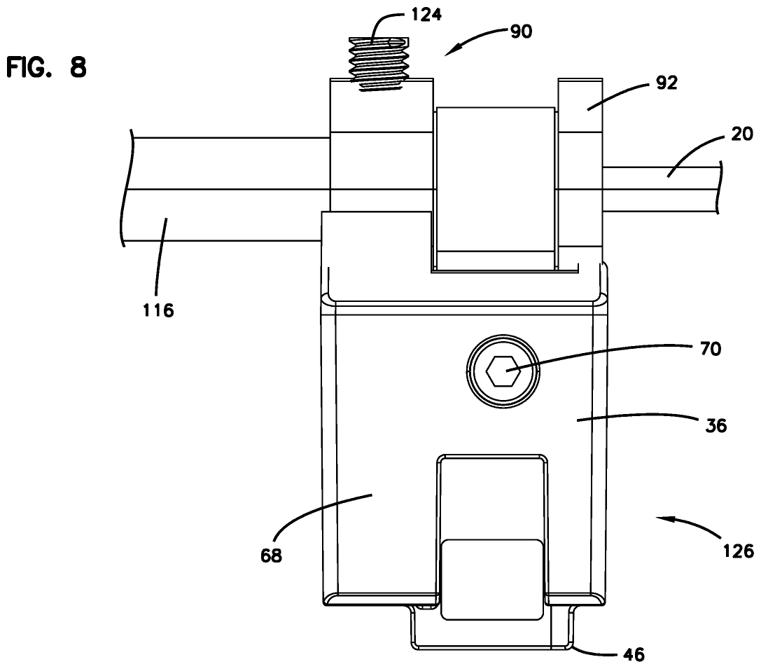

Referring to FIGS. 5-8, an alternative cable termination unit 126 is shown. The cable termination unit 126 is used to seal a duct 116 and an inner cable in the duct 116 relative to the telecommunications enclosure 10. The cable termination unit 126 also fixes the duct 116 to the telecommunications enclosure 10 or to another piece of telecommunications equipment.

The cable termination unit 126 can include a main body 36 with a locking device 38. The main body 36 of the cable termination unit 126 can include a projection 40 that is configured to be positioned along a slot 42 defined in the locking device 38 when the locking device 38 is mounted inside an opening 44 defined by the main body 36. The locking device 38 can be secured within the main body 36 by a second fastener 48. The locking device 38 has an end face 62 that defines an aperture 64. When the locking device 38 is positioned within the main body 36, the aperture 64 of the locking device 38 aligns with an opening 66 defined in an end face 68 of the main body 36. A third fastener 70 can be mounted in the opening 66 during use. The main body 36 can also include an extending flange 46 for mounting the cable termination unit 126 within a slot defined in the seal block 22.

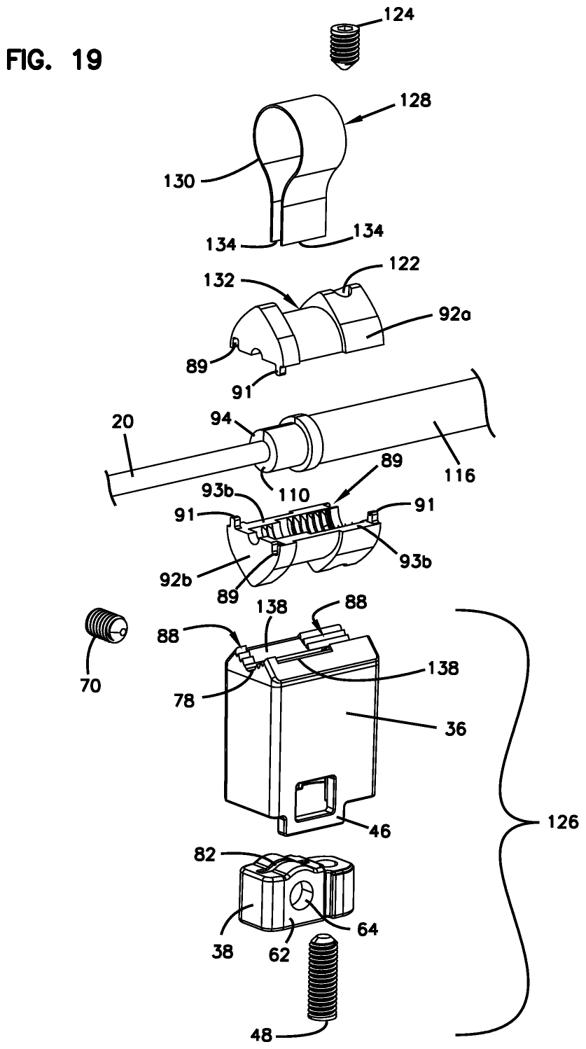

The cable termination unit 126 includes an attachment interface 72 located at a first end 74, opposite a second end 76 that defines the opening 44 of the main body 36. The attachment interface 72 defines a slot 78 (see FIG. 19) in a middle or center portion 80 thereof. When the locking device 38 is positioned inside of the main body 36, the slot 78 of the attachment interface 72 can align with a slot opening 82 defined by the locking device 38.

Left and right end portions 84, 86 of the attachment interface 72 can be positioned at respective first and second ends 74, 76 of the attachment interface 72. The left and right end portions 84, 86 can be located on opposite ends of the center portion 80 and can each include groove type fastening mechanisms 88 (e.g., teeth elements) that increases resistance of rotation of a sealing unit 90 (see FIG. 6) mounted thereon, although alternatives are possible. That is, the attachment interface 72 can be adapted for securing the sealing unit 90 thereon.

The sealing unit 90 can be adapted to seal the optical fiber cable 20. The sealing unit 90 can include a body member 92 and a sealing member 94 (see FIG. 9). The sealing unit 90 can have a distal end 96 and a proximal end 98. In certain examples, the body member 92 may comprise a polymeric material, although alternatives are possible. In certain examples, the body member 92 may be formed of a metallic material, although alternatives are possible.

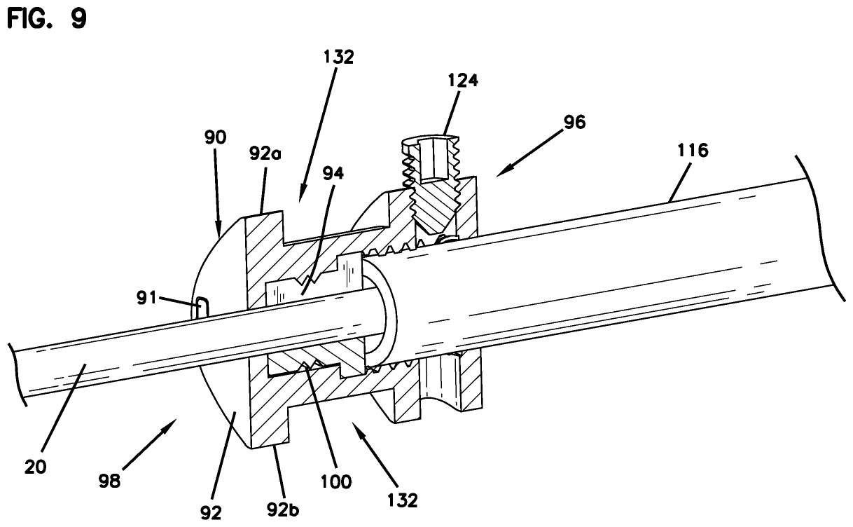

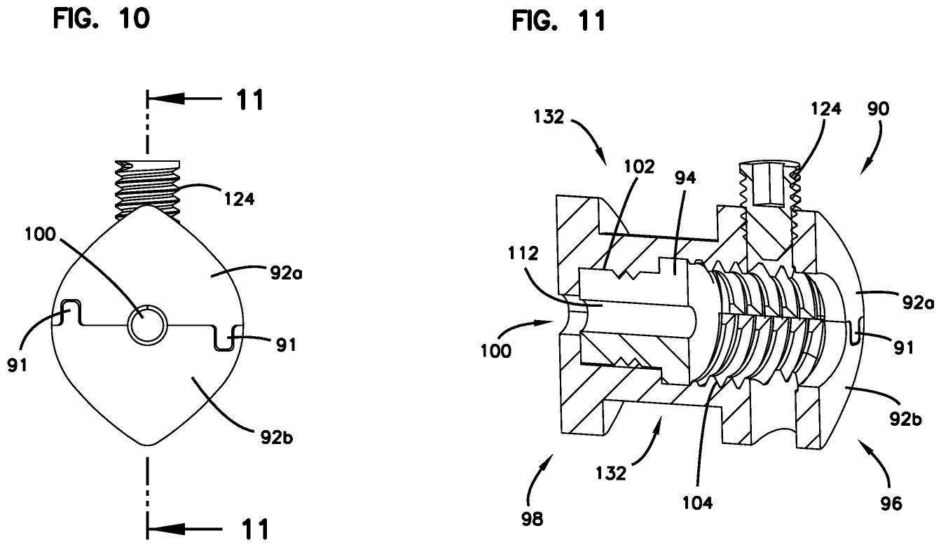

Turning to FIGS. 9-12, the body member 92 can define a passage 100 that extends lengthwise therethrough and receives the optical fiber cable 20. In certain examples, the body member 92 defines a first cavity 102 adjacent the proximal end 98 of the sealing unit 90 and a second cavity 104 adjacent the distal end 96 of the sealing unit 90.

The first cavity 102 can have a first inner diameter Di and the second cavity 104 can have a second inner diameter D2. In certain examples, the first inner diameter Di of the first cavity 102 is smaller than the second inner diameter D2 of the second cavity 104, although alternatives are possible. The passage 100 within the second cavity 104 of the body member 92 can include internal threads 106, although alternatives are possible. The internal threads 106 of the second cavity 104 can be formed from a metallic material.

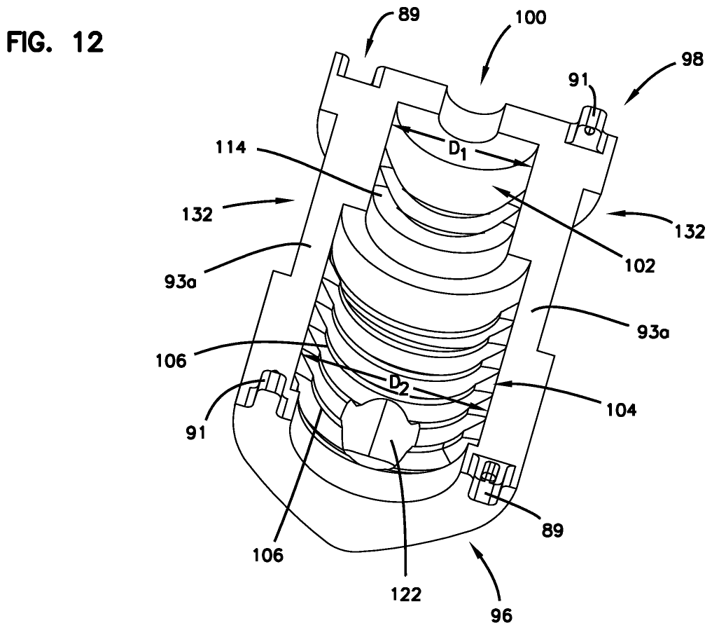

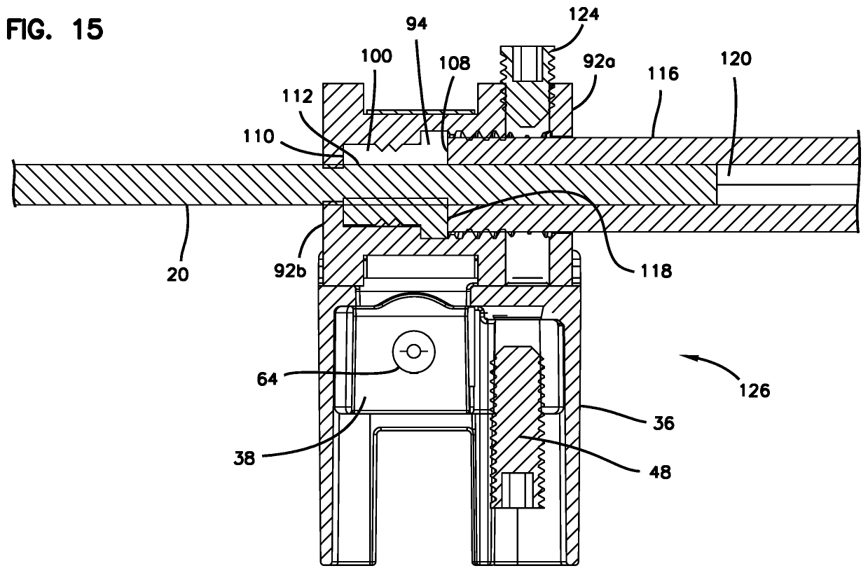

In certain examples, the body member 92 of the sealing unit 90 may be formed by two halves 92a, 92b (e.g., a first half, a second half, a pair of halves) that can be joined at respective first and second end faces 93a, 93b (see FIGS. 12 and 15) to be mated together. The two halves 92a, 92b are generally “eye-ball” shaped, although alternatives are possible. The two halves 92a, 92b can be constructed of plastic by an injection molding process. It is contemplated that other materials and other molding processes may be used for the construction of the sealing unit 90. The “eye-ball” shaped halves 92a, 92b of the body member 92 may be configured to fit into the v-shaped attachment interface 72 of the cable termination unit 126.

In certain examples, the two halves 92a, 92b can be attached via a snap-fit connection interface or a press fit connection, although alternatives are possible. When the two halves 92a, 92b are brought to coincide, the first and second cavities 102, 104 and the passage 100 are formed. In certain examples, the two halves 92a, 92b can each include at least one interface member 91 (e.g., projection, pin, knob, protrusion) that can be engageable with an opening 89 defined in the other one of the two halves 92a, 92b to mate the two halves 92a, 92b together as depicted in FIGS. 6, 7, 10, 11, and 14.

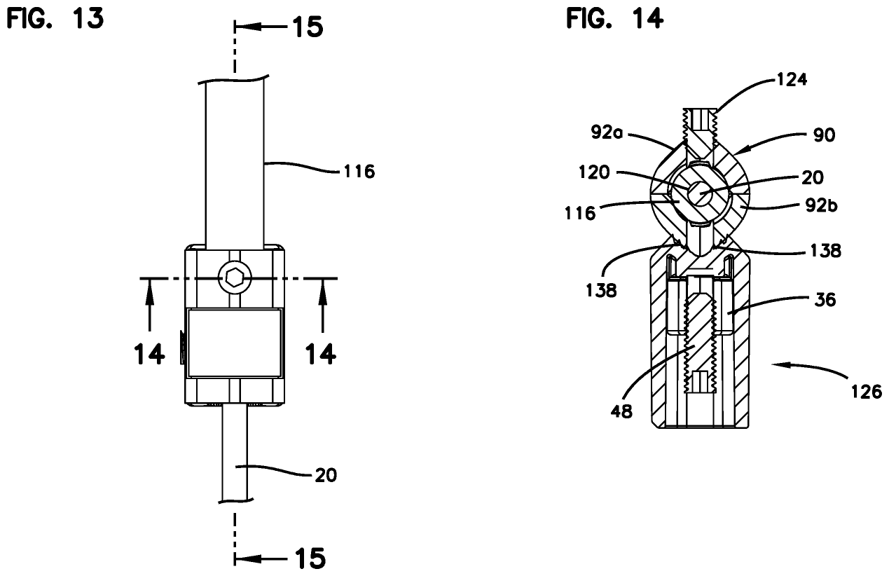

Referring to FIGS. 13-15, the sealing member 94 has a distal end face 108 and a proximal end face 110 (see FIG. 15). In certain examples, the sealing member 94 can be configured as a radial wrap or wrap around, although alternatives are possible. In the example depicted, the sealing member 94 is configured with a straight slit, although alternatives are possible.

The sealing member 94 may comprise of a rubber material. In certain examples, the sealing member 94 may be formed with an extrusion profile.

The sealing member 94 can be mounted within the first cavity 102 of the body member 92. The sealing member 94 defines a passage 112 for receiving the optical fiber cable 20 when the optical fiber cable 20 is blown or pushed through the sealing unit 90. In certain examples, the sealing member 94 can be secured about the optical fiber cable 20 prior to the sealing member 94 being mounted within the first cavity 102 of the body member 92. The sealing member 94 can be configured to create a seal about the optical fiber cable 20 when the optical fiber cable 20 is routed therethrough. That is, the sealing member 94 can provide a 360 degree seal about the optical fiber cable 20. The first cavity 102 may include ribs 114 that are arranged and configured to compress the sealing member 94 when the two halves 92a, 92b are connected together to improve sealing. The ribs 114 can push the sealing member 94 into the optical fiber cable 20 to create a seal about the optical fiber cable 20 and the first cavity 102.

In certain examples, a duct 116 may be positioned within the second cavity 104 of the body member 92 of the sealing unit 90. The duct 116 can define a passage 120 (see FIG. 15) for which the optical fiber cable 20 may be blown or pushed through, although alternatives are possible. In certain examples, the optical fiber cable 20 can be configured to float down the duct 116. The duct 116 can be formed from a plastic material. The duct 116 can be rotated, twisted, or turned inside of the second cavity 104 such that the internal threads 106 of the second cavity 104 cut into the duct 116 to drive the duct 116 forward to abut the distal end face 108 of the sealing member 94. As such, the duct 116 can be configured to press against the sealing member 94 to create a seal at an end 118 of the duct 116 such that there is no leak path. That is, the end 118 of the duct 116 can be sealed against the distal end face 108 of the sealing member 94 to seal a leak point. The sealing member 94 seals the duct 116 to prevent any liquid or fluid from moving out therefrom. As such, any air gap between the optical fiber cable 20 and the duct 116 can be sealed against any leak points.

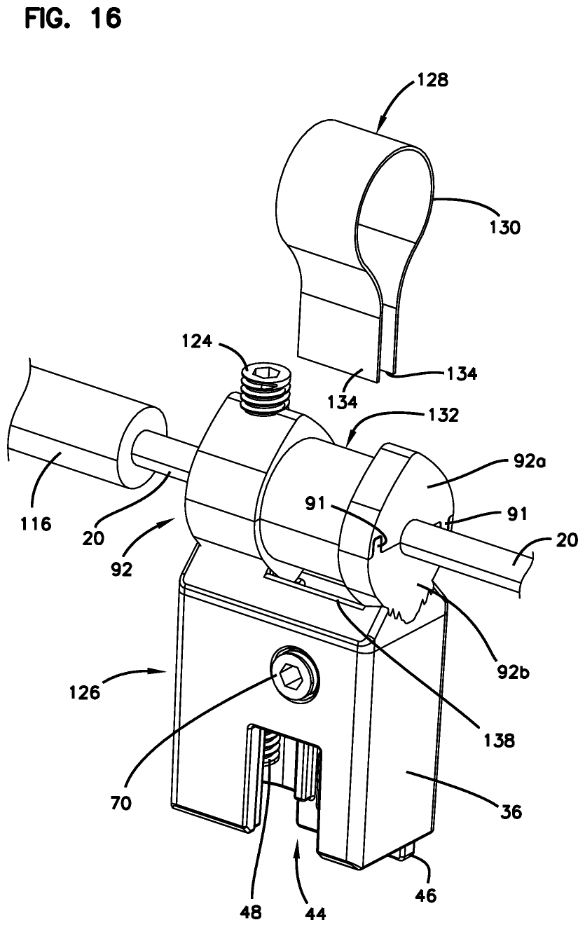

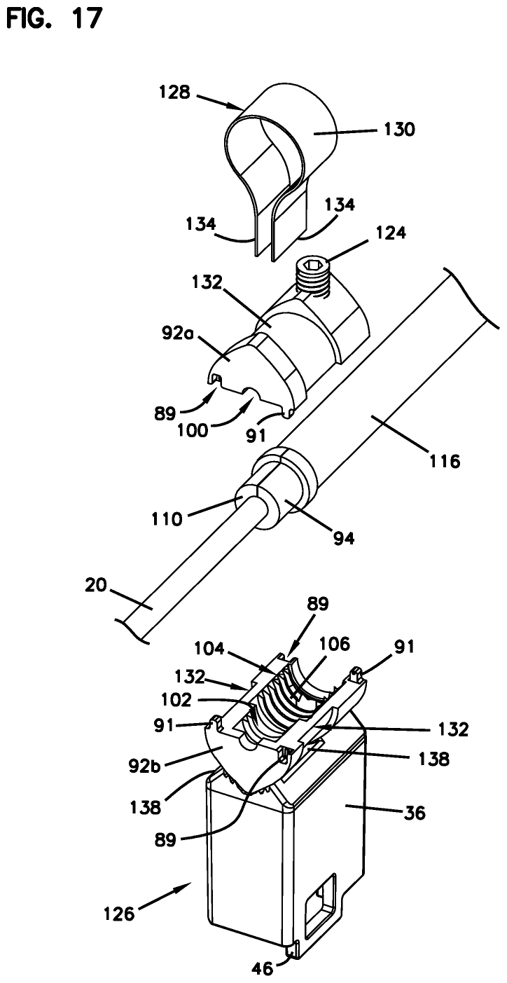

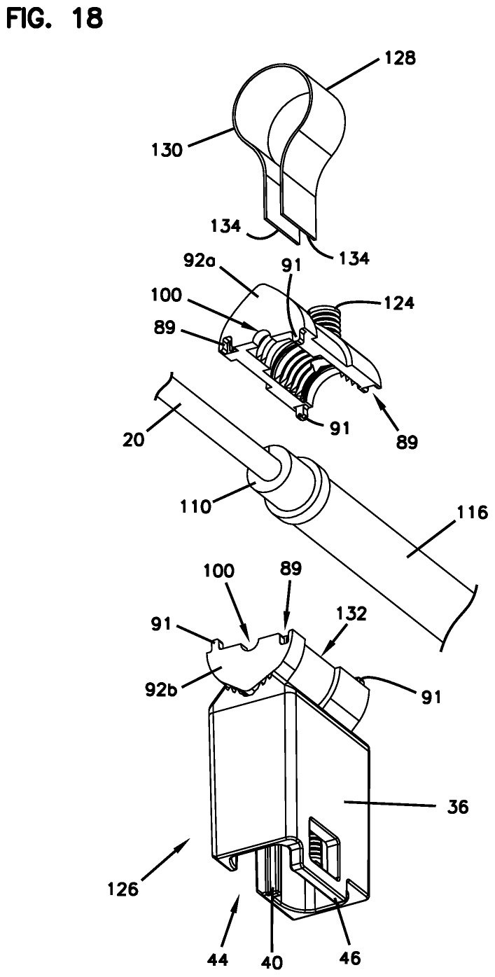

Turning to FIGS. 16-19, the body member 92 of the sealing unit 90 can further define an aperture 122 adapted to receive a fourth fastener 124. The fourth fastener 124 can be adapted to releasably fix the duct 116 in selective axial positions in the body member 92 such that the duct 116 can withstand axial pull. That is, the fourth fastener 124 can be used to hold the duct 116 in position within the body member 92. In certain examples, the fourth fastener 124 is a set screw, although alternatives are possible. The fourth fastener 124 can be screwed into the aperture 122 until flush with (i.e., even with) the body member 92 to prevent the duct 116 from unscrewing. That is, the fourth fastener 124 can be inserted fully into an interior of the body member 92.

The body member 92 can be attached to the cable termination unit 126 and tighten thereon via a strap 128. The cable termination unit 126 may be grounded or ungrounded. In certain examples, a grounding clip may be positioned to contact a metallic shield of a cable.

The strap 128 can include a loop 130, for disposing around the body member 92 within a recess 132 thereof, which has two axially spaced apart free ends 134. The free ends 134 can be adapted to be positioned on opposing sides 138 of the cable termination unit 126 for retention therein to secure the body member 92 to the cable termination unit 126. That is, the strap 128 can be tightened around the body member 92 to simultaneously fix and seal the duct 116.

The free ends 134 of the strap 128 can be received within the slot 78 of the attachment interface 72 and within the slot opening 82 defined by the locking device 38 to be retained therein. In certain examples, the strap 128 can be adjustable in length to accommodate different diameter cables.

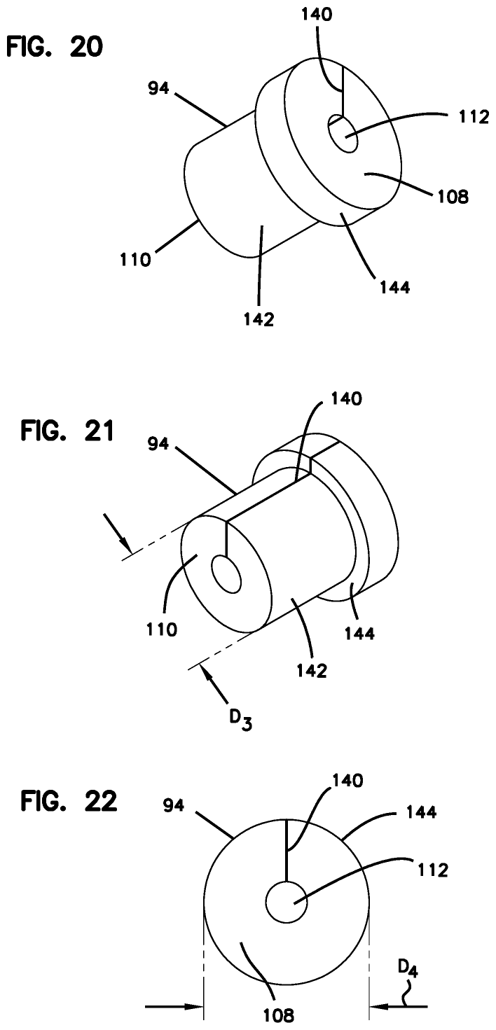

Referring to FIGS. 20-22, details of the sealing member 94 are shown. The sealing member 94 includes a slit 140 that allows the sealing member 94 to be configured as a radial wrap or wrap around, although alternatives are possible. The sealing member 94 may include a main body portion 142 and a flange portion 144. The main body portion 142 may be monolithically formed with the flange portion 144 to define a one-piece unit, although alternatives are possible. The main body portion 142 of the sealing member 94 may define a first outer diameter D₃ and the flange portion 144 of the sealing member 94 may define a second outer diameter D₄. In certain examples, the first outer diameter D₃ of the sealing member 94 is smaller than the second outer diameter D₄ of the sealing member 94.

Another aspect of the present disclosure relates to a method for sealing and fixing a duct for routing a fiber optic cable. The method can include the steps of 1) providing a duct 116 with an optical fiber cable 20; 2) mounting the sealing member 94 around the optical fiber cable 20 such that the end face 108 of the sealing member 94 abuts the duct 116; 3) joining the two halves 92a, 92b of the sealing unit 90 together over the sealing member 94 and the duct 116; 4) attaching the strap 128 to the sealing unit 90; 5) tightening the strap 128 over the sealing unit 90 to squeeze the sealing member 94 over the optical fiber cable 20 and to squeeze the duct 116; 6) twisting the duct 116 against threads in the sealing unit 90 to such that the duct 116 is sealed against the sealing member 94; and 7) screwing the fourth fastener 124 into the sealing unit 90 to engage and axially secure the duct 116.

The method can also include a step of securing the sealing unit 90 to the cable termination unit 126 via another set screw located in the cable termination unit 126.

The various examples and teachings described above are provided by way of illustration only and should not be construed to limit the scope of the present disclosure. Those skilled in the art will readily recognize various modifications and changes that may be made without following the examples and applications illustrated and described herein, and without departing from the true spirit and scope of the present disclosure.

What is claimed is:

1. A sealing unit for sealing an optical fiber cable, the sealing unit comprising:
a body member having a distal end and a proximal end, the body member defining a first passage that extends lengthwise therethrough, the body member defining a first cavity adjacent the proximal end, the first cavity having a first diameter and the body member defining a second cavity adjacent the distal end, the second cavity having a second diameter; and
a sealing member having a distal end face and a proximal end face, the sealing member being mounted within the first cavity of the body member, the sealing member defining a second passage for receiving the optical fiber cable, the sealing member being configured to create a seal about the optical fiber cable when the optical fiber cable is routed therethrough;
wherein the first passage includes internal threads within the second cavity of the body member; and
wherein when in use, a duct is rotated inside the second cavity of the body member such that the internal threads of the second cavity cut into the duct to drive the duct forward to abut the distal end face of the sealing member.

2. The sealing unit of claim 1, wherein the body member includes two halves.

3. The sealing unit of claim 2, wherein the two halves are mated together via a connection interface.

4. The sealing unit of claim 3, wherein when the two halves are brought to coincide, the first and second cavities are formed.

5. The sealing unit of claim 1, wherein the body member further defines an aperture adapted to receive a fastener for releasably fixing the duct in selective axial position in the body member.

6. The sealing unit of claim 5, wherein the fastener is a set screw.

7. The sealing unit of claim 1, wherein the body member is attached to a cable termination unit via a strap.

8. The sealing unit of claim 7, wherein the strap includes a loop configured to mount within a recess of the body member, the strap having two free ends adapted to be received within receptacles on opposing sides of the cable termination unit to secure the body member to the cable termination unit.

9. The sealing unit of claim 1, wherein the body member comprises a polymeric material.

10. The sealing unit of claim 1, wherein the internal threads are formed from a metallic material.

11. The sealing unit of claim 1, wherein the first diameter of the first cavity is smaller than the second diameter of the second cavity.

12. A method for sealing and fixing a duct for routing an optical fiber cable, the method comprising:
providing a duct including an optical fiber cable;
mounting a sealing member around the optical fiber cable such that an end face of the sealing member abuts the duct;
joining two halves of a sealing unit together over the sealing member and the duct;
attaching a strap to the sealing unit;
tightening the strap over the sealing unit to squeeze the sealing member over the optical fiber cable and to squeeze the duct;
twisting the duct against threads in the sealing unit such that the duct is sealed against the sealing member; and
screwing a fastener into the sealing unit to engage and axially secure the duct.

13. The method of claim 12, wherein the two halves of the sealing unit define a first diameter corresponding to a first cavity and a second diameter corresponding to a second cavity.

14. The method of claim 12, further comprising a step of attaching the sealing unit to a cable termination unit.

15. The method of claim 14, wherein the strap has free ends that are adapted to be positioned on opposite sides of the cable termination unit.

16. The method of claim 13, wherein the first diameter is smaller than the second diameter.

17. A sealing coupling component comprising:
a sealing unit having a body member, the body member including a first end and an opposite second end, the body member defining an inner passage that extends through the body member between the first and second ends of the body member along an axis, the body member having a first housing piece and a second housing piece that are configured to mate together, the first housing piece defining a first cavity with a first diameter, the second housing piece defining a second cavity with a second diameter, the second cavity having internal metal threads;
a sealing member located in the first cavity, the sealing member defining a passage;
an optical fiber cable being positioned within the passage of the sealing member, the sealing member providing a seal thereabout; and
a duct adapted to mount into the second cavity such that the internal metal threads cut into the duct to drive the duct forward to abut against an end face of the sealing member to prevent fluid flow through the sealing unit when the first and second housing pieces are in a closed position.

18. The sealing coupling component of claim 17, wherein the sealing unit further defines an aperture adapted to receive a fastener for releasably fixing the duct in selective axial position in the sealing unit.

19. The sealing coupling component of claim 18, wherein the fastener is a set screw.

20. The sealing coupling component of claim 17, wherein the sealing unit is attached to a cable termination unit via a strap, wherein the strap includes a loop configured to mount within a recess of the sealing unit, the strap having two free ends adapted to be received within receptacles on opposing sides of the cable termination unit to secure the sealing unit to the cable termination unit.
